(19) United States
(12) Patent Application Publication
(10) Pub. No.: US 2018/0227789 A1
(43) Pub. Date: Aug. 9, 2018

(54) INTELLIGENT FORWARDING OF PHONE ACTIVITIES ACCORDING TO PRESENT USER CONTEXT

(71) Applicant: QUALCOMM Incorporated, San Diego, CA (US)

(72) Inventors: Prudhvi KOTHAPALLI, India (IN); Suresh Kumar BITRA, Mangalagiri (IN); Sreekanth HOSAHUDYA VENKATARAMANAPPA, Hyderabad (IN)

(21) Appl. No.: 15/428,592

(22) Filed: Feb. 9, 2017

(51) Int. Cl. H04W 28/02; H04L 29/08

(52) U.S. Cl. CPC H04W 28/0215; H04W 84/18; H04L 67/24

(57) ABSTRACT

If a user is using a second device and wants to manage and/or perform certain operations of the user device, the user may experience inconvenience from shifting the user's attention to the user device. Therefore, an intelligent approach to enable the user to manage and/or perform an operation of the user device on the second device. According to an aspect of the disclosure. the apparatus may be a user device for managing a device operation. The user device determines user activity context information associated with a plurality of devices, the plurality of devices including the user device and at least one second user device. The user device selects at least one device from the plurality of devices based on the user activity context information. The user device forwards an operation of the user device to the selected at least one device to perform the operation at the selected at least one device.

### BACKGROUND

### Field

The present disclosure relates generally to managing operations of a user device, and more particularly, to selective forwarding of an operation of a user device to an appropriate device.

### Background

A user device (e.g., user equipment (UE)) may be configured to communicate with one or more second devices, for example, via wireless communication. The user device may communicate with one or more second devices via a local area network, a wireless wide area network, and/or device-to-device communication. Types of second devices with which the user device may communicate has been increasing over time. For example, a user device may be configured to communicate with one or more of a wearable device, glasses with mobile device capabilities, a tablet, some other mobile device, a laptop computer, a car infotainment system, etc. The user device's communication capability with one or more second devices may allow implementation of various features to increase user satisfaction with the device. In one example, the user device may collect information from one or more second devices and may utilize the collected information. In another example, the user device may send information to a second device such that a user may view the information using the second device. Therefore, various approaches have been under development to increase user satisfaction with the user device and one or more second devices coupled to the user device.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A user may have a user device such as a user equipment (UE) or a mobile device. The user device may alert a user of certain upcoming operations or a displayed notification. For example, the user device may receive a telephone call or a text message, or may display an event notification on the user device. If the user is using a second device and wants to manage and/or perform certain operations on the user device, the user may need to shift the user's attention from the second device to the user device in order to use the user device for such operations. Such a shift of attention interrupts the user's work on the second device and thus may cause inconvenience. Therefore, an approach to enable the user to manage and/or perform an operation of the user device on a second device while the user is working on the second device is desired.

In an aspect of the disclosure, a method, a computer-readable medium, and an apparatus are provided. The apparatus may be a user device for managing a device operation. The user device determines user activity context information associated with a plurality of devices, the plurality of devices including the user device and at least one second user device. The user device selects at least one device from the plurality of devices based on the user activity context information. The user device forwards an operation of the user device to the selected at least one device to perform the operation at the selected at least one device.

In an aspect, the apparatus may be a user device for managing a device operation. The user device includes means for determining user activity context information associated with a plurality of devices, the plurality of devices including the user device and at least one second user device. The user device includes means for selecting at least one device from the plurality of devices based on the user activity context information. The user device includes means for forwarding an operation of the user device to the selected at least one device to perform the operation at the selected at least one device.

In an aspect, the apparatus may be a user device for managing a device operation that includes a memory and at least one processor coupled to the memory. The at least one processor is configured to: determine user activity context information associated with a plurality of devices, the plurality of devices including the user device and at least one second user device, select at least one device from the plurality of devices based on the user activity context information, and forward an operation of the user device to the selected at least one device to perform the operation at the selected at least one device.

In an aspect, a computer-readable medium storing computer executable code for a user device for managing a device operation includes code to: determine user activity context information associated with a plurality of devices, the plurality of devices including the user device and at least one second user device, select at least one device from the plurality of devices based on the user activity context information, and forward an operation of the user device to the selected at least one device to perform the operation at the selected at least one device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is an example diagram illustrating a user device being coupled to several second devices.

FIG. 2 is an example diagram illustrating a scenario where a user is using a second device away from a user device.

FIG. 3 is an example diagram illustrating interactions between a user device and second devices, according to an aspect of the disclosure.

FIGS. 4A and 4B are example diagrams illustrating interactions between a user device and second devices based on user's activity context, according to an aspect of the disclosure.

FIGS. 5A and 5B are example diagrams illustrating interactions between a vehicle infotainment system and a user device based on user's activity context, according to an aspect of the disclosure.

FIG. 6 is a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Devices may be coupled to each other and may communicate with each other through communication connections between the devices. For example, a user device (e.g., mobile device such as a UE) may be coupled to one or more second devices (e.g., Internet-of-Things (IoT) devices or another UE) such as wearable devices, glasses with mobile device capabilities, tablets, other mobile devices, laptop computers, a car infotainment system, etc. The user device may be coupled to the one or more second devices via one or more of communication methods such as wireless wide area network (WWAN), a local area network (LAN) (e.g., wireless LAN (WLAN)), and device-to-device (D2D) communication (e.g., based on FlashLinQ, WiMedia, Bluetooth, ZigBee, or Wireless local area network based on the IEEE 802.11 standard). The user device may communicate with one or more of the second devices based on availability of the second devices and/or accessibility permissions/authentication to access the second device. In an aspect, the user device may determine availability of a second device based on whether the second device is turned on, and/or whether the second device is coupled to the user device, and/or whether the device is within proximity of the user device.

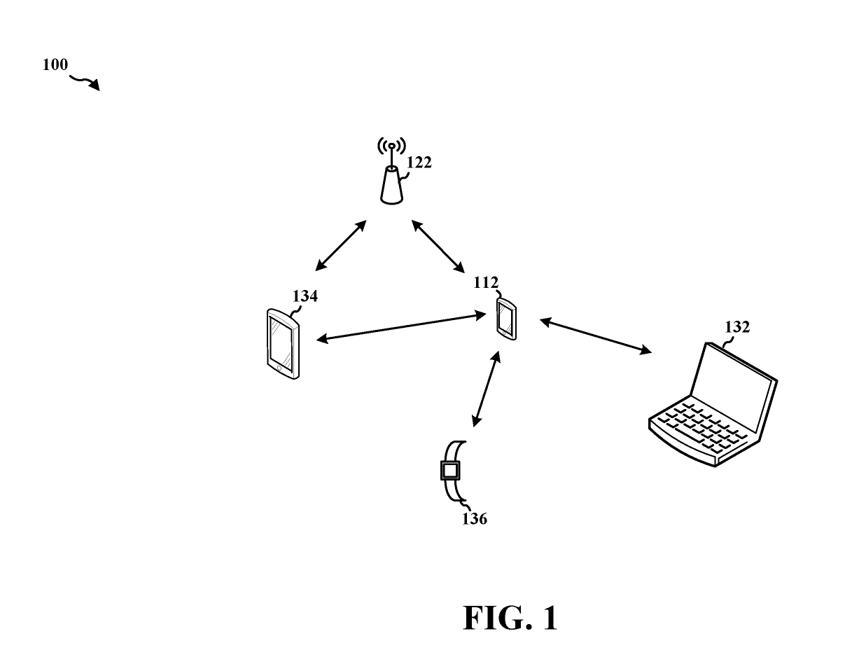

FIG. 1 is an example diagram 100 illustrating a user device coupled to several second devices. As illustrated in FIG. 1, the user device 112 may be coupled to a base station 122 that provides a WWAN service for the user device 112. A tablet device 134 is coupled to the base station 122. The user device 112 may be coupled to one or more second devices including a laptop computer 132, a tablet device 134, and a wearable device 136. In the example diagram 100 of FIG. 1, the tablet device 134 is coupled to the user device 112 via WWAN provided by the base station 122, the laptop computer 132 is coupled to the user device 112 via WLAN, and the wearable device 136 is coupled to the user device 112 via D2D communication. The user device 112 may be able to determine availability of each second device based on whether the second device is turned on, and/or whether the second device is coupled to the user device 112, and/or whether the device is within proximity of the user device 112.

The user device may initiate and perform various operations regardless of whether the user is actively using the user device (e.g., whether the user is interacting with the user device). Thus, the user device may initiate and/or perform various operations even when the user is not actively using the user device. For example, the user may be actively working on a laptop computer (e.g., using a keyboard, a touchpad, etc.) when the user device activates an event notification/alert such as an alarm and thus displays the event notification and/or plays a ringtone for the event notification. In such a scenario, the user may become aware of a corresponding event when the user shifts his or her attention from the laptop computer to the user device to determine the event notification (e.g., notification of a call or a message) displayed on the user device and/or hearing the ringtone of the event notification from the user device. For example, in a scenario where a user is in an office and is actively using a laptop computer, if the user receives a telephone call or a text message on the user device (e.g., a mobile phone or a wearable device), the user may need to pull the user device out of a pocket or a bag to perform a certain action (e.g., receive the call or view and/or respond to the message). However, if the user is working with a second device (e.g., laptop computer) when the event notification occurs in the user device, the user may experience inconvenience caused by switching his or her attention from the second device to the user device to determine the event notification of the user device.

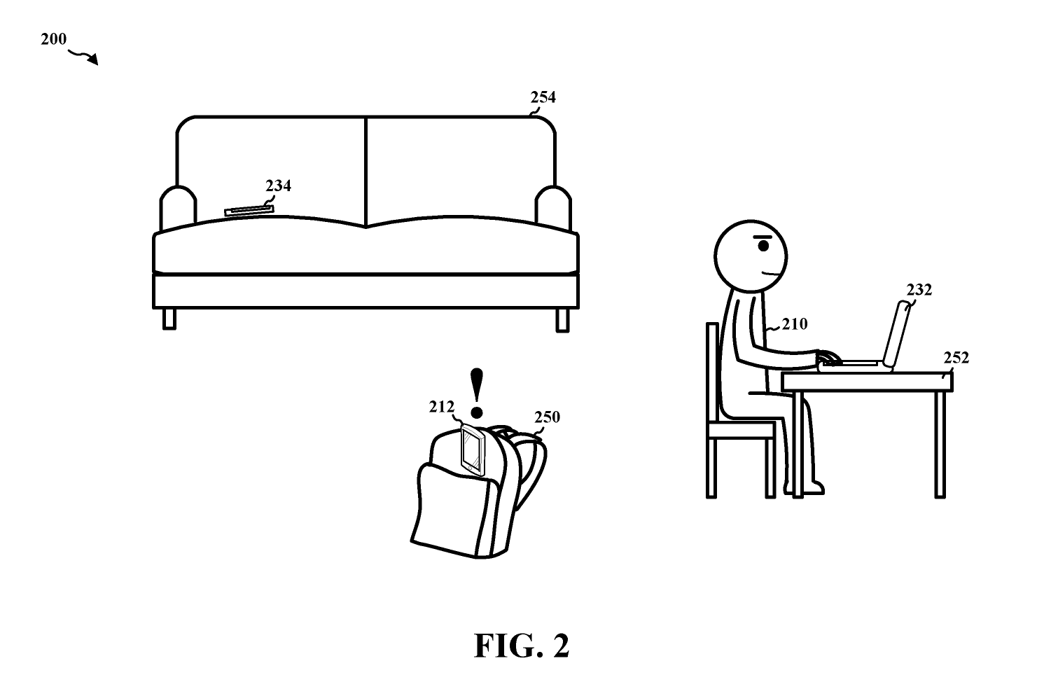

FIG. 2 is an example diagram 200 illustrating a scenario where a user is using a second device away from a user device. In the example diagram 200 of FIG. 2, a user device 212 is coupled to one or more second devices including a laptop computer 232 and a tablet device 234. The user device 212 may be inside of a bag 250. The laptop computer 232 is located on a desk 252. The tablet device 234 is located on a sofa 254. In the example diagram 200 of FIG. 2, a user 210 is presently using the laptop computer 232. Thus, if the user wants to perform an operation on the user device 212, the user 210 may experience inconvenience from walking from the desk 252 to the bag 250 and taking out the user device 212 to use the user device 212 for the operation. For example, if the user device 212 receives an update/service (e.g., a text message) and the user 210 wants to check the update/service of the user device 212, the user 210 may stop working on the laptop computer 232, walk to the bag 250, and take out the user device 212 to check the update/service using the user device 212. Thus, if the user 210 wants to check the update/service of the user device 212, the user experiences an interruption when working on the laptop computer 232.

According to one configuration, the user device may be configured such that updates and/or notifications at the user device may be forwarded to the one or more second devices (e.g., a personal computer) coupled to the user device. Because the updates and/or notifications of the user device are forwarded to all of the second devices, when the user is working with a particular second device, the user may be made aware of the updates and/or notifications via the particular second device, without having to switch his or her attention to the user device. However, as discussed below, such a configuration may not provide an optimal user experience, especially when the update/notification is forwarded to all of the second devices coupled to the user device. Forwarding the updates/notifications of the user device to all of second devices coupled to the user device may result redundant communication of the updates/notifications across the second devices coupled with the user device. The redundant communication may inconvenience the user by triggering updates/notifications of the user device in second devices that the user is not working with. For example, the redundant communication may trigger an alarm sound in one or more second devices that the user is not using. Further, the redundant communication may consume additional network resources as well as resources in the second devices. In such a configuration, the user device does not consider the present user activity context with respect to the second devices when forwarding the user device updates.

User satisfaction with the user device may be increased by configuring the user device to take an intelligent action based on the context of user activities. In an aspect, when implementing device synchronization and offloading a device operation, the user device may consider the user's present activity context to increase user satisfaction with the user device and one or more second devices coupled to the user device. For example, in a scenario where a user receives a call or message on the user device (e.g., a mobile phone or a wearable device) while actively using a personal computer, the user satisfaction may be increased if the user is able to receive a call or a message on the personal computer instead of switching his or her attention to the user device because the user is already actively working with the personal computer.

According to an aspect of the disclosure, user experience may be optimized by determining the user's present activity context, detecting a particular device that is being used based on the user's present activity context, and accordingly forwarding an operation (e.g., services/updates) to the particular device. The operation of the user device that may be forwarded to the particular device may include at least one of a voice call (e.g., telephone call), a video call, a text message, an event notification, or an alarm notification. In an aspect, the user device may receive user activity context information associated with the one or more second devices from the one or more second devices, and may also gather the user activity context information of the user device itself. In an aspect, a user device may monitor or receive signals from multiple second devices coupled/paired with the user device in the proximity and determine the activity context information of the multiple second devices. Based on the activity context information associated with the user device and the multiple second devices, the user device may select a device out of the user device and the multiple second devices to forward an operation of the user device. Subsequently, the user device may forward the operation of the user device to the selected device. Thus, user activity context information with respect to one or more of the devices may be considered to allow the user device to intelligently forward an operation of the user device to an appropriate device based on the user activity context information.

In an aspect, the user device may check whether the second device to which the operation of the user device is forwarded performs the operation. In particular, if the user device forwards the operation of the user device to the second device, the second device may send a response message to the user device to indicate whether the second device performs the operation of the user device. If the message indicates that the second device is not performing the operation of the user device or if the user device does not receive a response message (e.g., for a certain time period), then the user device may perform the operation on the user device.

In an aspect, the user device may determine a device that is being actively used by a user based on the activity context information. Based on the activity context information associated with each device, the user device may intelligently determine if the user is active on a particular device. Because the user is likely to pay attention to the device the user is using, the device used by the user may be selected as the destination device for forwarding the operations of the user device. In one example, based on activity context information of the user device and one or more second devices surrounding the user device, the user device may determine that a user is using a particular second device, and thus may select the particular second device as a destination for forwarding one or more operations of the user device. In another example, based on information on the user activity and context with regard to second devices and the user device, the user device may determine that the user is working on the user device, and thus may forward the operation of the user device to an appropriate component within the user device (e.g., without forwarding the operation of the user device to a second device). Thus, based on the activity context information, the user device may determine whether to forward an operation of the user device to a particular device, and may determine whether the user device itself should perform the operation of the user device.

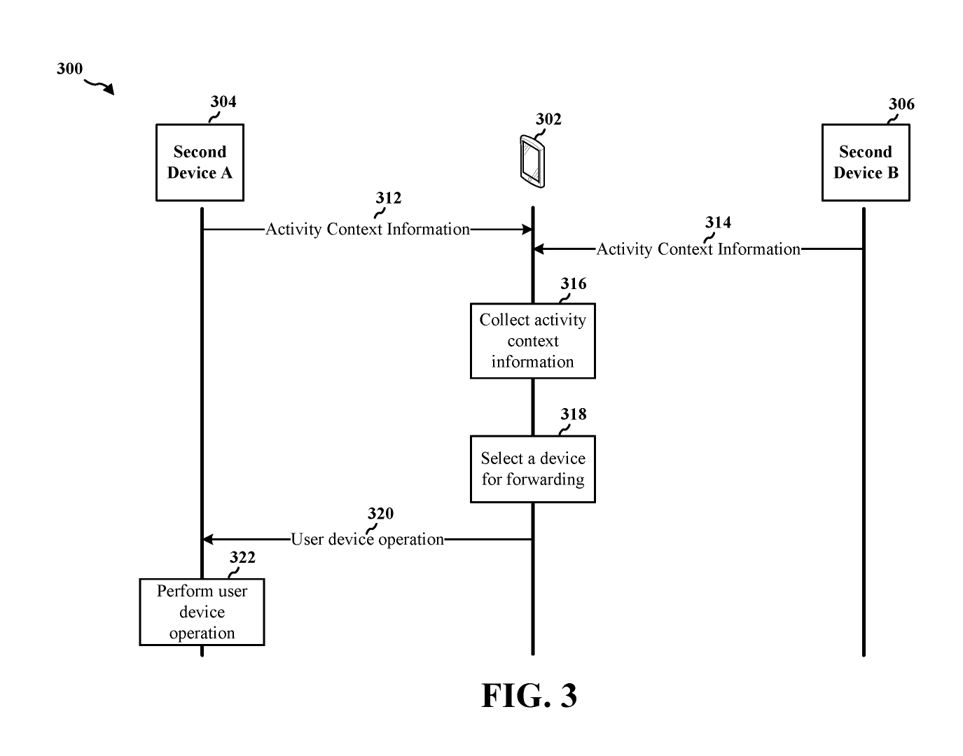

FIG. 3 is an example diagram 300 illustrating interactions between a user device and one or more second devices, according to an aspect of the disclosure. The example diagram 300 illustrates interactions between a user device 302 and two second devices including a second device A 304 and a second device B 306. At 312, the user device 302 receives activity context information associated with the second device A 304. At 314, the user device 302 receives activity context information associated with the second device B 306. At 316, the user device 302 collects activity context information associated with the user device 302. At 318, based on the activity context information associated with the user device 302, the second device A 304, and the second device B 306, the user device 302 selects a device (e.g., among the user device 302, the second device A 304, and the second device B 306) to forward an operation of the user device 302. In the example diagram 300, the user device 302 selects the second device A 304. Thus, at 320, the user device 302 forwards the operation of the user device 302 to the second device A 304. At 322, the second device A 304 performs the operation of the user device 302.

In an aspect, the user device may determine the activity context information for a device based on one or more of a hardware activity of a device, a software activity of the device, user motion detected by the device, and a peripheral device (e.g., a headphone, a touchpad, etc.) coupled to the device. The hardware activity includes at least one of a display device activity, a processor activity, or a memory device activity. For example, if the hardware activity information of a device in the activity context information indicates an active hardware activity (e.g., active display screen, hardware processor activity), the user device may determine that the device is being actively used by a user and thus may select the device. The software activity of a device may include activities associated with a software application and/or activities associated with communication/internet activity. In one example, the activity context information may be based on a status update of the user's social media and/or electronic communication medium, where the status update may indicate whether the user is available, active, away, etc. The user motion may include one or more of a mouse movement, a keyboard input stroke, a touch screen being touched, or user motion sensed by a sensor, and the activity context information may be based on the data on the user motion. In one example, the activity context information in a device may be based on collection of various types of information including wearable device data obtained from a wearable device (e.g., data indicating whether a user is walking, jogging, or running, as well as indication of hand orientation, etc.), where the wearable device data may be collected via a motion sensor. In one example, the activity context information may be based on a peripheral device (e.g., a headphone) connection and the user triggering a software application to play music in a device.

In one example, the user device and the second devices may be logged into a same social media account. In such an example, activity context information of a particular device may include information about the user activity (e.g., status update, browse history) as well as hardware activity, and/or software activity associated with the use of the social media account by the particular device. Thus, the user device may determine whether the user is actively using the social media account on a particular device based on the activity context information. If the user device determines that the user is actively using the social media account on the particular device, the user device selects the particular device and forwards the user device operation to the particular device. If the user device later determines based on activity context information that the user has stopped using the particular device (e.g., the user has moved away from the particular device), then the user device may revert back to performing the user device operation on the user device.

In an aspect, the activity context information of a device may include an amount of time that has elapsed since the most recent user activity on the device. Thus, for example, the activity context information may include an amount of time between the device's determination of the activity context information and the most recent user activity on the device. For example, the amount of time that has elapsed since the most recent user activity on the device may determine whether the user is presently using a device. Thus, for example, if a long time (e.g., a time exceeding a threshold time) has elapsed since the most recent user activity, the user device may determine that the user is not presently using the device. If the elapsed time indicated by the activity context information of a device has not exceeded a threshold time, the user device may select the device to forward an operation of the user device. If the elapsed time has exceeded the threshold time, the user device may select the user device itself to forward an operation of the user device to a component of the user device to perform the operation (e.g., without forwarding the operation to a second device).

Even if activity context information of a second device indicates that the second device is actively used, the user device may select the user device to perform an operation of the user device due to certain conditions as follows. In an aspect, the user device may select the user device to perform the operation of the user device if the second device is not available to the user device. For example, after the user device receives the activity context information of second devices, the user device may lose connection to the second devices or may power off. In such an example, the user device cannot forward operation to any of the second devices that are not coupled with the user device, and thus selects the user device to perform the operation of the user device.

In an aspect, the user device may select a device to forward an operation of the user device based on device capabilities (e.g., hardware capabilities such as capabilities associated with speakers, a microphone, a mouse, a keyboard, software capabilities, etc.). In particular, the user device may select a device that is capable of performing the operation of the user device to be forwarded from the user device. In an aspect, the user device may receive device capability information from each of the one or more second devices along with the corresponding activity context information. In one example, if a second device is not capable of performing a particular operation of the user device (e.g., receive a telephone call) due to lack of a certain feature (e.g., a microphone), the user device may not forward the particular operation of the user device to the second device. In such an example, the user device may forward the operation to another second device that is capable of performing the particular operation and is also actively used according to the activity context information, or the user device itself may perform the operation if there is no other second device that is actively used according to the activity context information.

In an aspect, the user device may select a device to forward an operation of the user device based on a priority level of the device. If multiple devices are available for selection by the user device, the user device may consider the priority level of each device of the multiple devices. For example, activity context information from the multiple devices may indicate that two or more devices of the multiple devices are suitable for selection (e.g., are actively being used by the user). For example, if the user that has a wearable device on an arm is working on a laptop and is also moving his arm frequently to use a mouse, the activity context information from the wearable device and the laptop may indicate that both the wearable device and the laptop are being actively used. In such an example, if a priority level of the laptop is higher than a priority level of the wearable device, the user device may select the laptop to forward the operation of the user device.

In an aspect, when selecting a device to forward an operation of the user device based on activity context information, the user device may collect information about whether each device has performed an operation forwarded by the user device over a set period of time, and select a device to forward the operation based on the collected information. For example, if the collected information indicates that the user has used the laptop to receive a telephone call many times in the past (e.g., during the past 24 hours) while the user is working on the laptop, then the user device may forward the telephone call to the laptop if the user is working on the laptop. On the other hand, for example, if the user has used the user device to receive a telephone call in the past even when the user is working on the laptop, then the user device may perform the operation associated with the telephone call.

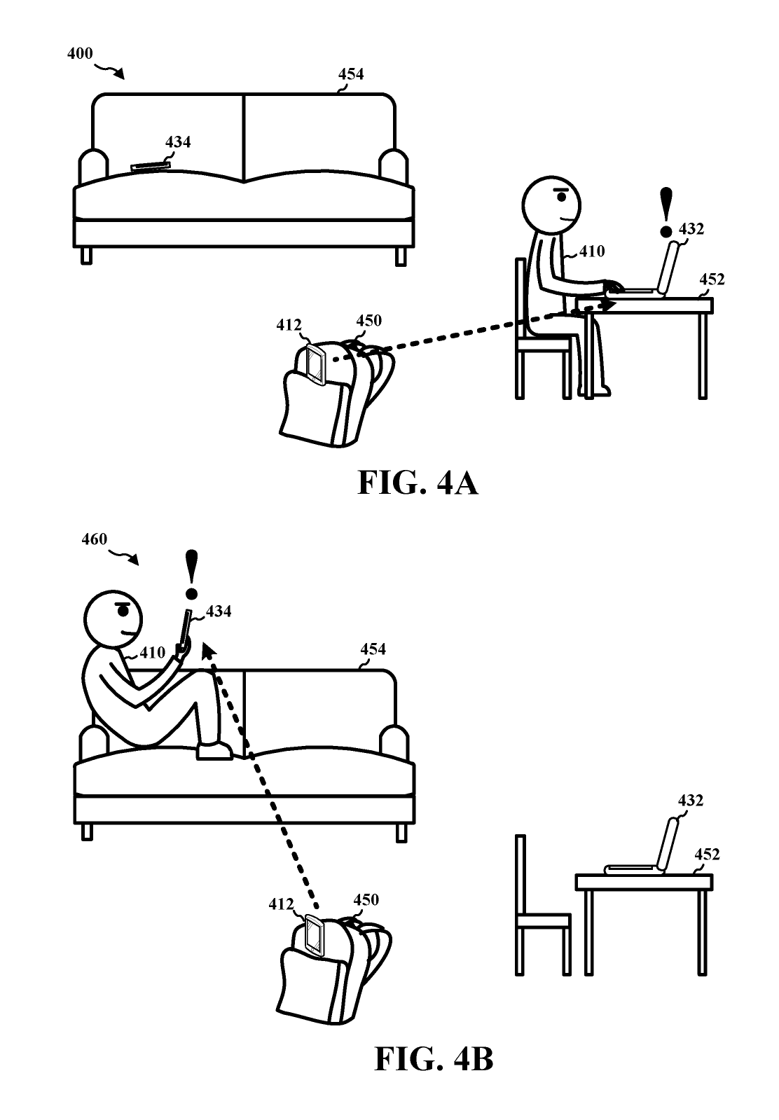

FIGS. 4A and 4B are example diagrams illustrating interactions between a user device and second devices based on user's activity context, according to an aspect of the disclosure. FIG. 4A is an example diagram 400 illustrating a case where a user is using a laptop computer. In the example diagram 400 of FIG. 4A, a user device 412 is coupled to a laptop computer 432 and a tablet device 434. The user device 412 is inside of a bag 450. The laptop computer 432 is placed on a desk 452. The tablet device 434 is placed on a sofa 454. In the example diagram 400 of FIG. 4A, a user 410 is currently using the laptop computer 432. If the user device 412 receives a telephone call, the user device 412 may select one of the tablet device 434 and the laptop computer 432 to forward the telephone call. Because the user 410 is currently using the laptop computer 432, the context activity information of the laptop computer 432 may include one or more of an active keyboard stroke, active display screen, active use of software applications, etc., which indicate that the user 410 is active on the laptop computer 432. On the other hand, the context information of the tablet device 434 and the user device 412 may include inactive display screen (e.g., display screen in a power save mode), inactive use of software applications, etc., which indicates that the tablet device 434 and the user device 412 are not currently used by the user 410. Therefore, the user device 412 may select the laptop computer 432 based on such context activity information, and then forward the telephone call to the laptop computer 432. As such, the user 410 may take the telephone call via the laptop computer 432 while working on the laptop computer 432.

FIG. 4B is an example diagram 460 illustrating a case where a user is using a tablet device. In the example diagram 460, the user 410 is currently using the tablet device 434 while sitting on the sofa 454. Because the user 410 is currently using the tablet device 434, the context activity information of the tablet device 434 may include one or more of active display screen, active use of software applications, active use of portions of hardware (e.g., a volume button), etc. which indicate that the user 410 is active on the tablet device 434. On the other hand, the context information of the laptop computer 432 and the user device 412 may include inactive display screen, inactive use of software applications, etc., which indicates that the laptop computer 432 and the user device 412 are not currently used by the user 410. Therefore, when the user device 412 receives a telephone call, the user device 412 may select the tablet device 434 based on such context activity information, and then forward the telephone call to the tablet device 434. As such, the user 410 may take the telephone call using the tablet device 434 while actively using the tablet device 434.

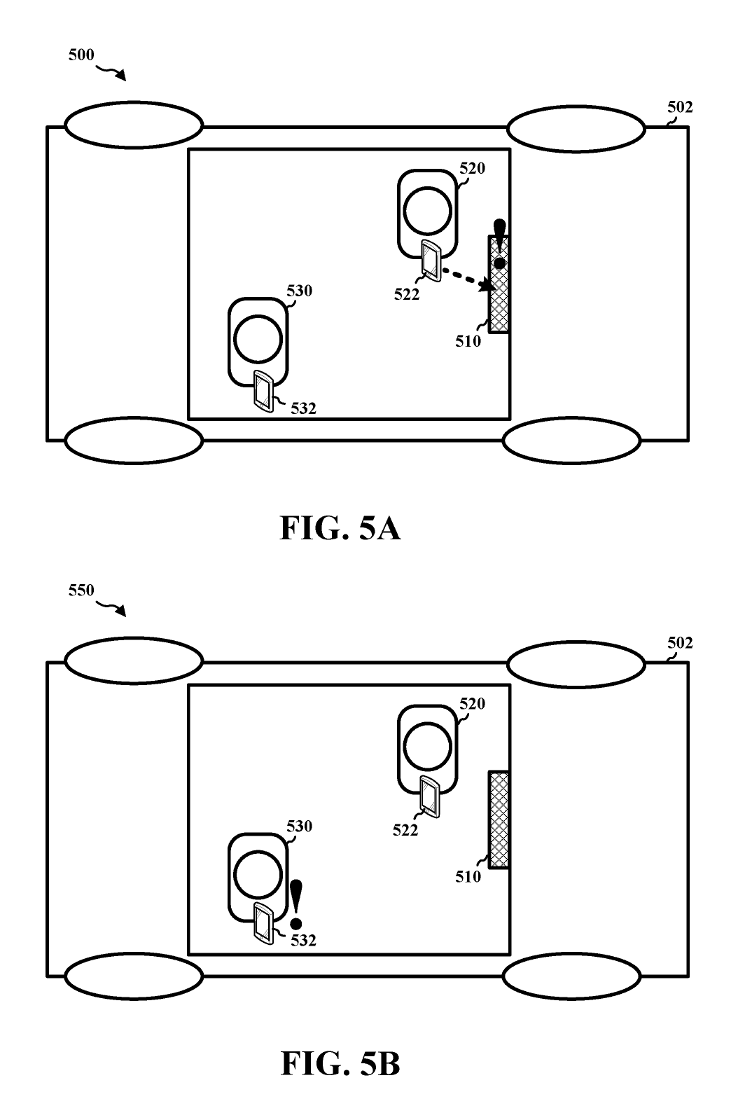

FIGS. 5A and 5B are example diagrams illustrating interactions between a vehicle infotainment system and a user device based on a user's activity context, according to an aspect of the disclosure. FIG. 5A is an example diagram 500 illustrating interactions between a vehicle infotainment system and a user device of a driver with regard to an operation of the user device of the driver, according to an aspect of the disclosure. FIG. 5B is an example diagram 550 illustrating interactions between a user device within a vehicle infotainment system and a user equipment of a passenger with regard to an operation of the user device of the passenger, according to an aspect of the disclosure. As illustrated in the example diagrams 500 and 550, a vehicle 502 includes a vehicle infotainment system 510 capable of communicating with a user device, and has a driver 520 and a passenger 530. The driver 520 has a user device 522 and the passenger 530 has a user device 532. Based on activity context information, the user device 522 may determine that the user device 522 is with the driver 520 and that the user device 532 is with the passenger 530. For example, the user device 522 may determine that the user device 522 is with the driver 520 based on a round-trip time of a signal between the user device 522 and the vehicle infotainment system 510 or based on a location sensor capable of sensing that the user device 522 is on or near a seat of the driver 520. In such an example, the round-trip time and/or the information from the location sensor may be included in the activity context information. Similarly, for example, the user device 522 may determine that the user device 532 is with the passenger 530 based on a round-trip time of a signal between the user device 532 and the vehicle infotainment system 510 or based on a location sensor capable of sensing that the user device 532 is on or near a seat of the passenger 530. As the user device 522 determines that the user device 522 is with the driver 520, the user device 522 may forward an operation of the user device 522 to the vehicle infotainment system 510. Thus, as illustrated in the example diagram 500 of FIG. 5A, when the user device 522 receives a telephone call, the user device 522 may forward the telephone call to the vehicle infotainment system 510 such that the driver 520 may take the telephone call via a speaker-microphone feature of the vehicle infotainment system 510. Since the driver 520 is currently driving, forwarding the operation of the user device 522 to the vehicle infotainment system 510 helps the driver 520 perform operations of the user device 522 via the vehicle infotainment system 510 while driving.

On the other hand, as the user device 532 determines that the user device 532 is with the passenger 530, the user device 532 may not forward an operation of the user device 532 to the vehicle infotainment system 510. Instead, the user device 532 may perform the operation of the user device 532. Thus, as illustrated in the example diagram 550 of FIG. 5B, when the user device 532 receives a telephone call, the user device 532 performs the operation related to the telephone call such that the passenger 530 may take the telephone call using the user device 532. Because the passenger 530 is not driving, the passenger 530 may use the user device 532 directly without relying on the vehicle infotainment system 510.

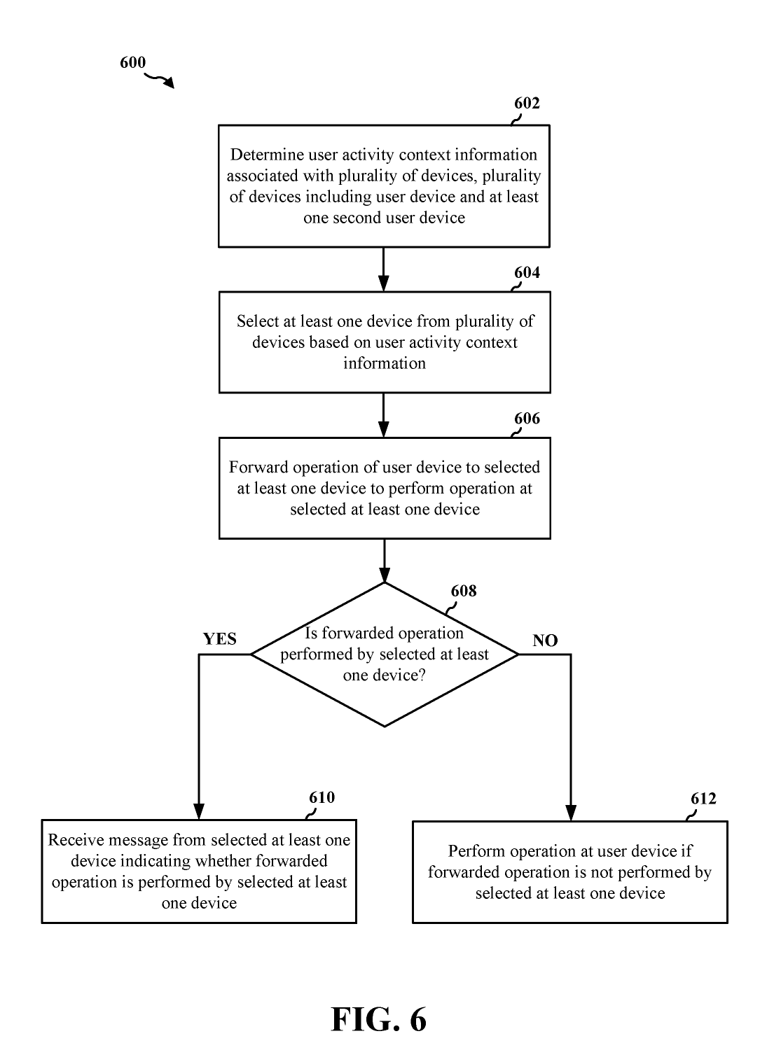

FIG. 6 is a flowchart 600 of a method of wireless communication. The method may be performed by a user device (e.g., the user device 302, the apparatus 702/702′). At 602, the user device determines user activity context information associated with a plurality of devices, the plurality of devices including the user device and at least one second user device. In an aspect, the user device may determine the user activity context information by receiving the user activity context information from the at least one second user device, where the user activity context information is associated with the at least one second user device. For example, as discussed supra, the user device may receive user activity context information associated with the second devices from the second devices, and may also gather the user activity context information associated with the user device itself

In an aspect, the user activity context information may be determined based on at least one of: a hardware activity of each of the plurality of devices, a software activity of each of the plurality of devices, user motion detected by one or more of the plurality of devices, or a peripheral device connection to one or more of the plurality of devices. For example, as discussed supra, the user device may determine the activity context information for a device based on one or more of a hardware activity of a device, a software activity of the device, user motion detected by the device, motion of device, and a peripheral device (e.g., a headphone, a touchpad, etc.) coupled to the device. In such an aspect, the hardware activity may include at least one of a display device activity, a processor activity, or a memory device activity, the software activity may include at least one of a software application activity or an internet activity, and the user motion may include one or more of a mouse movement, a keyboard input stroke, or user motion sensed by a sensor.

At 604, the user device selects at least one device from the plurality of devices based on the user activity context information. For example, as discussed supra, based on the activity context information associated with the user device and the second devices, the user device may select a device from the user device and the second devices to forward an operation of the user device. In an aspect, the at least one device may be selected further based on a capability of each device of the plurality of devices. For example, as discussed supra, the user device may select a device to forward an operation of the user device based on device capabilities (e.g., hardware capabilities such as capabilities associated with speakers, a microphone, a mouse, a keyboard, software capabilities, etc.). In such an aspect, the selected at least one device may be capable of performing the operation. For example, as discussed supra, the user device may select a device that is capable of performing the operation of the user device to be forwarded from the user device.

In an aspect, the user device may select the at least one device further based on a priority level of each device of the plurality of devices. For example, as discussed supra, the user device may select a device to forward an operation of the user device based on a priority level of the at least one device. For example, as discussed supra, if multiple devices are available for selection by the user device, the user device may consider the priority level of each device of the multiple devices.

In an aspect, the user device may select the at least one device by selecting the at least one device if a threshold time has not elapsed since the most recent user activity with the at least one device based on the user activity context information. For example, as discussed supra, if the elapsed time indicated by the activity context information of a device has not exceeded a threshold time, the user device may select the device to forward an operation of the user device. In such an aspect, the selected at least one device may be the user device if the threshold time has elapsed since the most recent user activity with the at least one second device. For example, as discussed supra, if the elapsed time has exceeded the threshold time, the user device may select the user device to forward an operation of the user device to an appropriate component of the user device for performing the operation.

In an aspect, the selected at least one device is the user device if the at least one second device is not available to the user device. For example, as discussed supra, after the user device receives the activity context information of the one or more second devices, the user device may select the user device to perform the operation if the second device is not available to the user device.

In an aspect, the user device may select the at least one device from the plurality of devices by: collecting information about whether each device of the plurality of devices performed one or more operations forwarded by the user device over a predetermined period of time, and selecting the at least one device further based on the collected information. For example, as discussed supra, when selecting a device to forward an operation of the user device based on activity context information, the user device may collect information about whether each device has performed an operation forwarded by the user device over a set period of time, and select a device to forward the operation based on the collected information.

At 606, the user device forwards an operation of the user device to the selected at least one device to perform the operation at the selected at least one device. For example, as discussed supra, after selection of a device based on the activity context information, the user device may forward the operation of the user device to the selected device. In an aspect, the operation may include at least one of a voice call, a video call, a text message, an event notification, or an alarm notification. For example, as discussed supra, the operation of the user device that may be forwarded to the particular device may include at least one of a voice call (e.g., telephone call), a video call, a text message, an event notification, or an alarm notification.

At 608, the user device may determine whether the forwarded operation is performed by the selected at least one device. For example, as discussed supra, the user device may check whether the second device to which the operation of the user device is forwarded is performing the operation. At 610, if the forwarded operation is performed by the selected at least one device, the user device may receive a message from the selected at least one device indicating whether the forwarded operation is performed by the selected at least one device. At 612, if the forwarded operation is not performed by the selected at least one device, the user device may perform the operation at the user device if the forwarded operation is not performed by the at least one device. For example, as discussed supra, if the user device forwards the operation of the user device to the second device, the second device may send a response message to the user device to indicate whether the second device performs the operation of the user device. For example, as discussed supra, if the message indicates that the second device does not perform the operation of the user device or if the user device does not receive a response message (e.g., for a certain time period), then the user device may perform the operation.

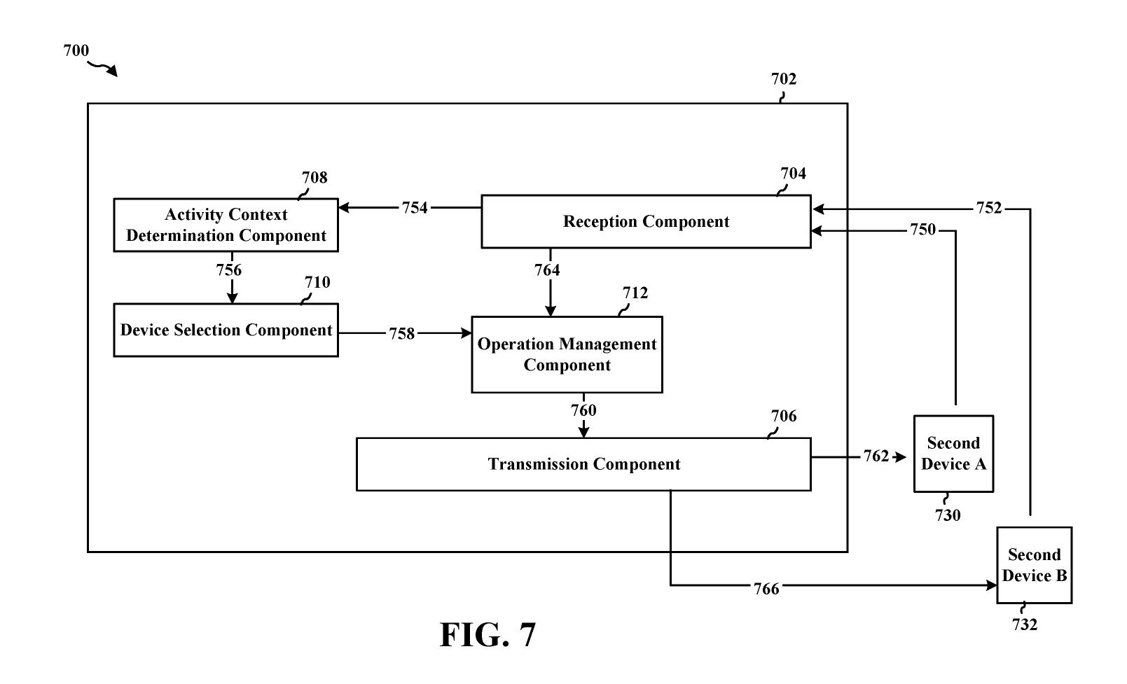

FIG. 7 is a conceptual data flow diagram 700 illustrating the data flow between different means/components in an exemplary apparatus 702. The apparatus may be a user device. The apparatus includes a reception component 704, a transmission component 706, an activity context determination component 708, a device selection component 710, and an operation management component 712.

The activity context determination component 708 determines user activity context information associated with a plurality of devices, the plurality of devices including the user device (apparatus 702) and at least one second user device (e.g., second device A 730, second device B 732). In an aspect, the activity context determination component 708 may determine the user activity context information by receiving, via the reception component 704, the user activity context information from the at least one second user device (e.g., second device A 730 at 750 and 754, second device B 732 at 752 and 754), where the user activity context information is associated with the at least one second user device. The activity context determination component 708 may forward the user activity context information to the device selection component 710, at 756.

In an aspect, the user activity context information may be determined based on at least one of: a hardware activity of each of the plurality of devices, a software activity of each of the plurality of devices, user motion detected by one or more of the plurality of devices, or a peripheral device connection to one or more of the plurality of devices. In such an aspect, the hardware activity may include at least one of a display device activity, a processor activity, or a memory device activity, the software activity may include at least one of a software application activity or an internet activity, and the user motion may include one or more of a mouse movement, a keyboard input stroke, or user motion sensed by a sensor.

The device selection component 710 selects at least one device (e.g., second device A 730) from the plurality of devices based on the user activity context information. The device selection component 710 may send information about the selection of the at least one device to an operation management component 712 at 758. In an aspect, the at least one device may be selected further based on a capability of each device of the plurality of devices. In such an aspect, the selected at least one device may be capable of performing the operation.

In an aspect, the device selection component 710 may select the at least one device further based on a priority level of each device of the plurality of devices.

In an aspect, the device selection component 710 may select the at least one device by selecting the at least one device if a threshold time has not elapsed since the most recent user activity with the at least one device based on the user activity context information. In such an aspect, the selected at least one device may be the user device if the threshold time has elapsed since the most recent user activity with the at least one second device.

In an aspect, the selected at least one device is the user device if the at least one second device is not available to the user device.

In an aspect, the device selection component 710 may select the at least one device by: collecting information about whether each device of the plurality of devices performed one or more operations forwarded by the user device over a predetermined period of time, and selecting the at least one device further based on the collected information.

The operation management component 712 forwards, via the transmission component 706, an operation of the user device to the selected at least one device (e.g., second device A 730 at 760 and 762) to perform the operation at the selected at least one device. In an aspect, the operation may include at least one of a voice call, a video call, a text message, an event notification, or an alarm notification.

The operation management component 712 may determine whether the forwarded operation is performed by the selected at least one device. If the forwarded operation is performed by the selected at least one device, the operation management component 712 may receive a message from the at least one device (e.g., second device A 730 at 750 and 764) indicating whether the forwarded operation is performed by the at least one device. If the forwarded operation is not performed by the selected at least one device, the operation management component 712 may perform the operation at the user device if the forwarded operation is not performed by the selected at least one device. The transmission component 706 may also be configured to transmit information to the second device B 732 at 766.

The apparatus may include additional components that perform each of the blocks of the algorithm in the aforementioned flowcharts of FIG. 6. As such, each block in the aforementioned flowcharts of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

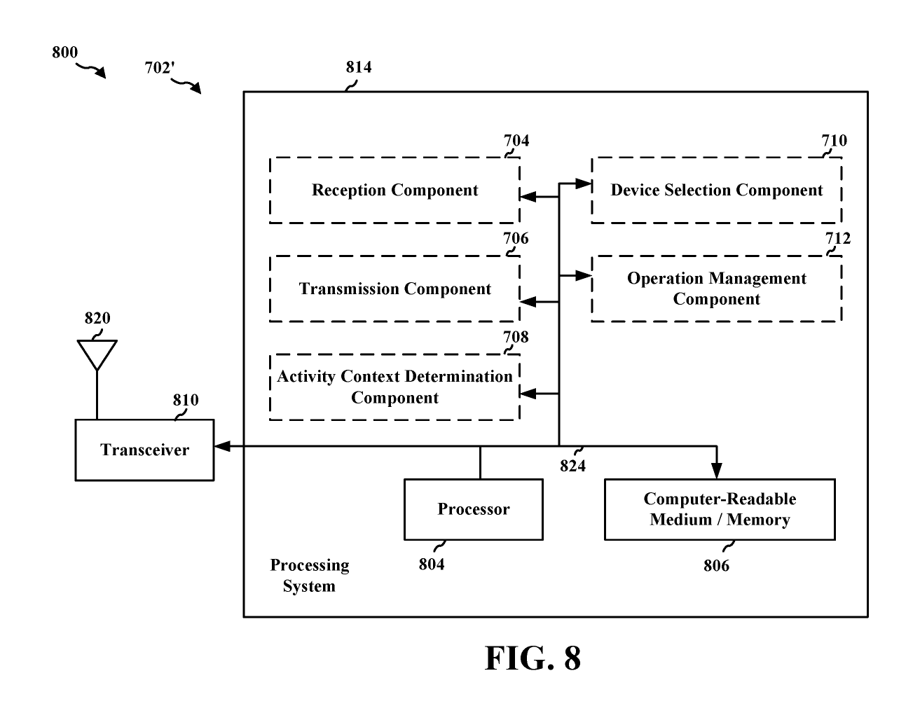

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, 712, and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 706, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710, 712. The components may be software components running in the processor 804, resident/stored in the computer readable medium/memory 806, one or more hardware components coupled to the processor 804, or some combination thereof.

In one configuration, the apparatus 702/702′ for wireless communication includes means for determining user activity context information associated with a plurality of devices, the plurality of devices including the apparatus 702/702′ and at least one second user device, means for selecting at least one device from the plurality of devices based on the user activity context information, and means for forwarding an operation of the apparatus 702/702′ to the selected at least one device to perform the operation at the selected at least one device. In an aspect, the apparatus 702/702′ may further include means for receiving a message from the selected at least one device indicating whether the forwarded operation is performed by the selected at least one device, and means for performing the operation at the apparatus 702/702′ if the forwarded operation is not performed by the at least one device. In an aspect, the means for determining the user activity context information may be configured to receive the user activity context information from the at least one second user device, where the user activity context information is associated with the at least one second user device.

In an aspect, the means for selecting the at least one device may be configured to select the at least one device further based on a priority level of each device of the plurality of devices. In an aspect, the means for selecting the at least one device may be configured to: select the at least one device if a threshold time has not elapsed since the most recent user activity with the at least one device based on the user activity context information. In an aspect, the means for selecting the at least one device is configured to: collect information about whether each device of the plurality of devices performed one or more operations forwarded by the apparatus 702/702′ over a predetermined period of time, and select the at least one device further based on the collected information.

The aforementioned means may be one or more of the aforementioned components of the apparatus 702 and/or the processing system 814 of the apparatus 702′ configured to perform the functions recited by the aforementioned means.

It is understood that the specific order or hierarchy of blocks in the processes / flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of managing a device operation by a user device, comprising:
determining user activity context information associated with a plurality of devices, the plurality of devices including the user device and at least one second user device;
selecting at least one device from the plurality of devices based on the user activity context information; and
forwarding an operation of the user device to the selected at least one device to perform the operation at the selected at least one device.

2. The method of claim 1, further comprising:
receiving a message from the selected at least one device indicating whether the forwarded operation is performed by the selected at least one device; and
performing the operation at the user device if the forwarded operation is not performed by the selected at least one device.

3. The method of claim 1, wherein the determining the user activity context information comprises receiving the user activity context information from the at least one second user device, wherein the user activity context information is associated with the at least one second user device.

4. The method of claim 1, wherein the user activity context information is determined based on at least one of:
a hardware activity of each of the plurality of devices,
a software activity of each of the plurality of devices,
user motion detected by one or more of the plurality of devices, or
a peripheral device connection to one or more of the plurality of devices.

5. The method of claim 4, wherein the hardware activity includes at least one of a display device activity, a processor activity, or a memory device activity,
wherein the software activity includes at least one of a software application activity or an internet activity, and
wherein the user motion includes one or more of a mouse movement, a keyboard input stroke, or the user motion sensed by a sensor.

6. The method of claim 1, wherein the at least one device is selected further based on a capability of each device of the plurality of devices.

7. The method of claim 6, wherein the selected at least one device is capable of performing the operation.

8. The method of claim 1, wherein the selecting the at least one device is further based on a priority level of each device of the plurality of devices.

9. The method of claim 1, wherein the selecting the at least one device comprises:
selecting the at least one device if a threshold time has not elapsed since the most recent user activity with the at least one device based on the user activity context information.

10. The method of claim 9, wherein the selected at least one device is the user device if the threshold time has elapsed since the most recent user activity with the at least one second device.

11. The method of claim 1, wherein the selected at least one device is the user device if the at least one second device is not available to the user device.

12. The method of claim 1, wherein the selecting the at least one device comprises:
collecting information about whether each device of the plurality of devices performed one or more operations forwarded by the user device over a predetermined period of time; and
selecting the at least one device further based on the collected information.

13. The method of claim 1, wherein the operation includes at least one of a voice call, a video call, a text message, an event notification, or an alarm notification.

14. A user device for managing a device operation, comprising:
means for determining user activity context information associated with a plurality of devices, the plurality of devices including the user device and at least one second user device;
means for selecting at least one device from the plurality of devices based on the user activity context information; and
means for forwarding an operation of the user device to the selected at least one device to perform the operation at the selected at least one device.

15. The user device of claim 14, further comprising:
means for receiving a message from the selected at least one device indicating whether the forwarded operation is performed by the selected at least one device; and
means for performing the operation at the user device if the forwarded operation is not performed by the selected at least one device.

16. The user device of claim 14, wherein the means for determining the user activity context information is configured to receive the user activity context information from the at least one second user device, wherein the user activity context information is associated with the at least one second user device.

17. The user device of claim 14, wherein the user activity context information is determined based on at least one of:
a hardware activity of each of the plurality of devices,
a software activity of each of the plurality of devices,
user motion detected by one or more of the plurality of devices, or
a peripheral device connection to one or more of the plurality of devices.

18. The user device of claim 14, wherein the at least one device is selected further based on a capability of each device of the plurality of devices.

19. The user device of claim 14, wherein the means for selecting the at least one device is configured to select the at least one device further based on a priority level of each device of the plurality of devices.

20. The user device of claim 14, wherein the means for selecting the at least one device is configured to:
select the at least one device if a threshold time has not elapsed since the most recent user activity with the at least one device based on the user activity context information.

21. The user device of claim 14, wherein the means for selecting the at least one device is configured to:
collect information about whether each device of the plurality of devices performed one or more operations forwarded by the user device over a predetermined period of time; and
select the at least one device further based on the collected information.

22. A user device for managing a device operation, comprising:
a memory; and
at least one processor coupled to the memory and configured to:
determine user activity context information associated with a plurality of devices, the plurality of devices including the user device and at least one second user device;
select at least one device from the plurality of devices based on the user activity context information; and
forward an operation of the user device to the selected at least one device to perform the operation at the selected at least one device.

23. The user device of claim 22, wherein the at least one processor is further configured to:
receive a message from the selected at least one device indicating whether the forwarded operation is performed by the selected at least one device; and
perform the operation at the user device if the forwarded operation is not performed by the selected at least one device.

24. The user device of claim 22, wherein the at least one processor configured to determine the user activity context information is configured to receive the user activity context information from the at least one second user device, wherein the user activity context information is associated with the at least one second user device.

25. The user device of claim 22, wherein the user activity context information is determined based on at least one of:
a hardware activity of each of the plurality of devices,
a software activity of each of the plurality of devices,
user motion detected by one or more of the plurality of devices, or
a peripheral device connection to one or more of the plurality of devices.

26. The user device of claim 22, wherein the at least one device is selected further based on a capability of each device of the plurality of devices.

27. The user device of claim 22, wherein the at least one processor is configured to select the at least one device further based on a priority level of each device of the plurality of devices.

28. The user device of claim 22, wherein the at least one processor configured to select the at least one device is configured to:
select the at least one device if a threshold time has not elapsed since the most recent user activity with the at least one device based on the user activity context information.

29. The user device of claim 22, wherein the at least one processor configured to select the at least one device is configured to:
collect information about whether each device of the plurality of devices performed one or more operations forwarded by the user device over a predetermined period of time; and
select the at least one device further based on the collected information.

30. A computer-readable medium storing computer executable code for a user device for managing a device operation, comprising code to:
determine user activity context information associated with a plurality of devices, the plurality of devices including the user device and at least one second user device;
select at least one device from the plurality of devices based on the user activity context information; and
forward an operation of the user device to the selected at least one device to perform the operation at the selected at least one device.
